(19) United States
(12) Patent Application Publication
(10) Pub. No.: US 2015/0323341 A1
(43) Pub. Date: Nov. 12, 2015

(54) GUIDANCE SYSTEM FOR ATTRACTIONS

(71) Applicant: Universal City Studios LLC, Universal City, CA (US)

(72) Inventors: Andrew Joseph Farrell, Orlando, FL (US); Vincent Schoenfelder, Midlothian, VA (US)

(73) Assignee: Universal City Studios LLC, Universal City, CA (US)

(21) Appl. No.: 14/275,571

(22) Filed: May 12, 2014

(51) Int. Cl. G01C 21/36

(52) U.S. Cl. CPC G01C 21/3644; G01C 21/3611

(57) ABSTRACT

A method in accordance with present embodiments includes receiving information indicating a selected destination from a pre-determined set of destinations in a geographic area and initial user location information. The method also includes determining a pedestrian route for the user to the destination through pre-determined waypoints based on the initial user location, wherein determining the pedestrian route comprises determining weighted geographic distances of a plurality of routes to the destination and selecting a route with a smallest or largest weighted geographic distance. The method also includes providing a plurality of images to the mobile device that correspond to respective intervening locations on the pedestrian route that the user will encounter while progressing on the pedestrian route to the destination;

### FIELD OF DISCLOSURE

The present disclosure relates generally to the field of amusement parks. More specifically, embodiments of the present disclosure relate to techniques for guiding park visitors to their desired destinations.

### BACKGROUND

Visitors to amusement parks (or theme parks) may have difficulty navigating within the park because their surrounding environments are unfamiliar. Further, in contrast to typical urban layouts, the pathways in an amusement park may not be arranged in a grid system with frequent intersections to permit multiple possible paths to any destination. For example, to enhance the visitor experience, the pathways in amusement parks may be winding or partially secluded to separate different park areas or rides from one another. In addition, park layouts may be organized by theme, with rides, shops, and restaurants within a theme being grouped together relatively close to one another but spaced relatively far away from the rides associated with a different theme. In addition, depending on the desired aesthetic goals of the park, pathway signs may be limited to only certain intersections or common areas. Accordingly, although visitors are provided with maps that indicate where major attractions are located, visitors may still get lost while walking from one attraction to another during their visit.

### SUMMARY

Certain embodiments commensurate in scope with the originally claimed subject matter are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from the embodiments set forth below.

In accordance with one embodiment, a system for guiding a user to a destination includes a memory storing instructions that, when executed, are configured to: receive a user input from a mobile device comprising a desired destination selected from a pre-determined set of destinations in a geographic area; receive initial user location information in the geographic area from the mobile device; determine a pedestrian route for the user to the desired destination through pre-determined waypoints based on the initial user location; associate the pedestrian route with a plurality of images corresponding to respective intervening locations on the pedestrian route that the user will encounter while progressing on the pedestrian route to the destination; and provide instructions to the mobile device to automatically trigger a display of one individual image of the plurality of images when the user is in a respective intervening location that corresponds to the individual image based on updated user location information from the mobile device, wherein the updated user location information is subsequent to the initial location information. The system also includes one or more processors configured to execute the instructions.

In accordance with another embodiment, a system includes a mobile device configured for wireless communication, the mobile device being configured to execute instructions to: transmit a selected destination from a pre-determined set of destinations in a geographic area; transmit initial location information accessed from a memory of the mobile device; receive a plurality of images that correspond to intervening locations on a pedestrian route to the destination and that the user will encounter while progressing on the pedestrian route to the destination; transmit updated location information accessed from a memory of the mobile device when the mobile device moves away from the initial location; and trigger a display an individual image of the plurality of images when the user is in a respective intervening location that corresponds to the individual image based on the updated location information, wherein the updated user location information is subsequent to the initial location information. The system also includes one or more processors configured to execute the instructions.

In accordance with another embodiment, a method includes receiving information indicating a selected destination from a pre-determined set of destinations in a geographic area and initial user location information; determining a pedestrian route for the user to the destination through pre-determined waypoints based on the initial user location, wherein determining the pedestrian route comprises determining weighted geographic distances of a plurality of routes to the destination and selecting a route with a smallest or largest weighted geographic distance; and providing a plurality of images to the mobile device that correspond to respective intervening locations on the pedestrian route that the user will encounter while progressing on the pedestrian route to the destination.

### DRAWINGS

These and other features, aspects, and advantages of the present disclosure will become better understood when the following detailed description is read with reference to the accompanying drawings in which like characters represent like parts throughout the drawings, wherein:

FIG. 1 is a schematic view of a user within a park employing a guidance system in accordance with present techniques;

FIG. 2 is a block diagram of the guidance system interaction with the mobile device in accordance with present techniques;

FIG. 3 is a flow diagram of a method for using the guidance system in accordance with present techniques;

FIG. 4 is an example of guidance system location-associated image displayed on a mobile device in accordance with present techniques;

FIG. 5 is a schematic view of certain route inputs in a geographic area in accordance with present techniques;

FIG. 6 is a flow diagram of a method for determining a route in conjunction with the guidance system in accordance with present techniques; and

FIG. 7 is a flow diagram of an embodiment of a method for determining a route in conjunction with the guidance system in accordance with present techniques.

### DETAILED DESCRIPTION

The present disclosure provides a guidance system for navigation through an amusement park or other destination. While users may use traffic or other map-based utilities for navigating public roads, navigation within a pedestrian area may present different challenges. Further, private facilities without public access roads may not be included in publically-available traffic or map information databases. Accordingly, available utilities for traffic may not provide useful information within an amusement park setting. In addition, a guidance system within the park may focus on providing an enjoyable experience that allows the user to focus on the park itself rather than focusing on a map and relating a map format to their immediate environment.

Accordingly, the guidance system provided herein is a dynamic, visual, and location-based system that guides a user through a series of images of intervening locations on a path to the desired destination. The user selects a desired destination, and the route is provided via images of one or more intervening locations on the route. The images are automatically displayed in series as the user traverses the path and may be displayed in a location-dependent manner. For example, the images may be automatically displayed when the system determines that the user is close to the area depicted in the image. When the user exits a particular location associated with an image, the next relevant image is displayed and so on, until the destination is reached.

In certain embodiments, the techniques herein for providing a route are map-independent, and no mapped display of the route determined by the system is provided. That is, while the present techniques may include one or more maps in other contexts (e.g., as used for providing an overview of the park or the available destinations), in certain embodiments the images are sent without any information that is displayed on a map. Accordingly, once the user selects a desired destination, visual image prompts are provided rather than a map or display included a map of the plotted route. Such a technique simplifies user navigation by limiting the available information, which in turn allows the user to focus on enjoying the park experience rather than attempting to determine the route themselves. For example, a map-based technique that shows a plotted route (e.g., shown in dotted lines on a map) in the context of a map may be overruled by the user, who may then use the map to select a different route, even one that is only slightly altered from the plotted route. While this may be desirable for navigation within a city, it is likely that a user within a theme park lacks experience with not only the park layout, but also the crowds at various attractions. To that end, the guidance system simplifies navigation by initially providing information about only a single route to the desired destination in the form of a series of images of the route. However, if the user veers off the determined route, the system may dynamically recalculate the route and provide additional/different images associated with the new route. In addition, the route-determination functionality may be contained within a remote guidance system such that a user's mobile device does not calculate any route to the destination, but instead only receives images, which may in turn help preserve the battery life of the mobile device.

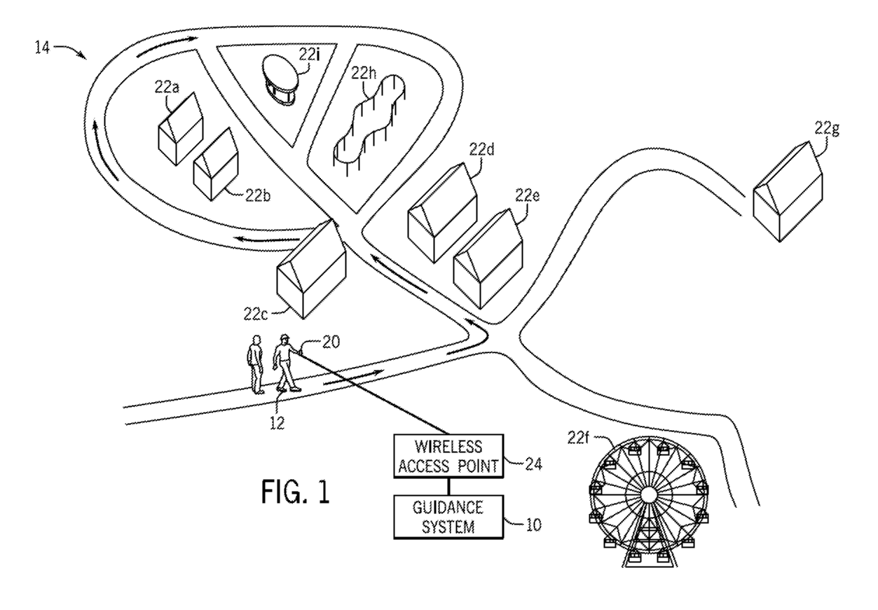

FIG. 1 is a schematic view of a guidance system 10 being accessed by a user 12 in a park 14 interacting with a mobile device 20. The park includes a number of destinations 22. If the user 12 is interested in guidance to a particular destination 22, the user 12 may select the destination (e.g., 22i) via the mobile device interface, such as via a drop-down menu or selectable images on the map. In certain embodiments, the mobile device 20 may include an application or specialty software package for interaction with the guidance system 10. The application is stored on the mobile device 20 and is configured to receive information from the guidance system 10 to provide to the user 12. In addition, the application is configured to provide user inputs and other information (e.g., GPS data) to the guidance system 10 as appropriate. In the depicted embodiment, the mobile device 20 may interact with the guidance system 10 through a wireless access point 24. In some embodiments or additionally, the mobile device 20 may communicate with the guidance system via a mobile base station.

The guidance system 10 receives the user input of the desired destination 22 and determines a best route to the destination 22. In one embodiment, the best route may not be the shortest route. For example, if the desired destination is 22i, the most direct route for the use r12 in the illustrated embodiment may include passing destination 22h. However, the guidance system 10 may receive user location information and determine, based on the location of the user 12 that destination 22h attracts large crowds at time periods associated with the current route request. Accordingly, in such a scenario, the best route determined by the guidance system 10 is a slightly longer route that avoids 22h and routes the user 12 by lower traffic attractions 22a and 22b.

Rather than providing a map of the route to the user 12, the guidance system 10, after determining the route, sends a series of images to the mobile device 20. When the user 12 starts walking on the route, the guidance system 10 receives updated location information and a particular image associated with the location is automatically displayed. In some embodiments, the entire series of images for a calculated or determined route may be provided in a single transmission or a series of initial transmission to avoid requesting continuous updates from the system 10. However, adjustment images may be provided if the system 10 determines that the user 12 has deviated from the route or additional information (e.g., crowd data) becomes available.

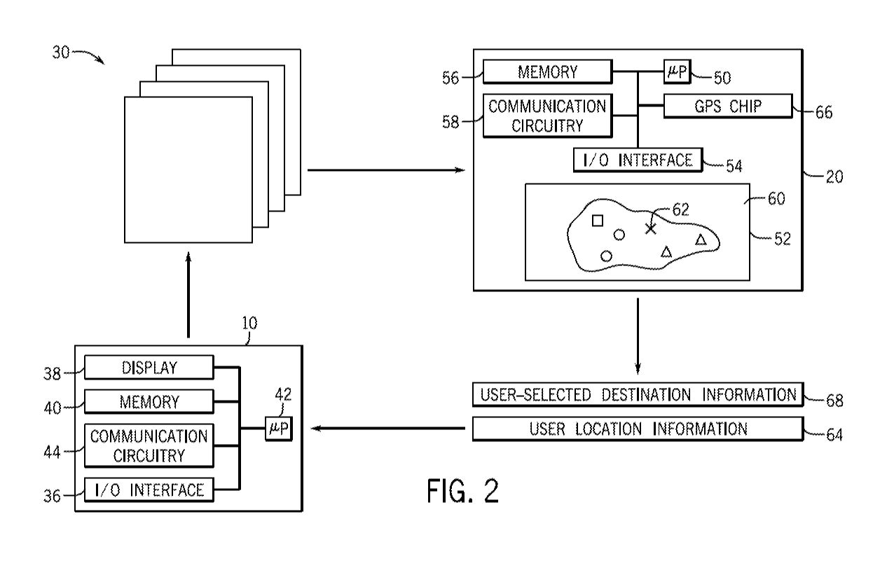

FIG. 2 is a block diagram of the communication interaction between the guidance system 10 and the mobile device 20 to facilitate transmitting route information (e.g., a series of images 30) to the user 12. The guidance system 10 may include various components that may allow for interaction with the mobile device 20 of a user 12. The guidance system 10 may a computer-based workstation including an input/output interface 36 and a display 38. The guidance system 10 may also include a memory device 40 for storing instructions executable by a processor 42 to perform the methods and control actions described herein. The processor 42 may include one or more processing devices, and the memory 40 may include one or more tangible, non-transitory, machine-readable media. By way of example, such machine-readable media can include RAM, ROM, EPROM, EEPROM, CD-ROM, or other optical disk storage, magnetic disk storage or other magnetic storage devices, or any other medium which can be used to carry or store desired program code in the form of machine-executable instructions or data structures and which can be accessed by the processor 42 or by any general purpose or special purpose computer or other machine with a processor. In addition, the guidance system 10 may be configured to include communication circuitry 44 to communicate over wireless communication paths, e.g., via wireless access points 24 (see FIG. 1). In one embodiment, data is transferred between the guidance system 10 and the mobile device 20 at least in part via a wireless network. While these components are discussed in the context of the guidance system 10, it should be understood that the mobile device 20 may also include similar features, such as a processor 50, display 52, user interface 54, memory 56, and wireless communication circuitry 58.

The mobile device 20 is shown with an example guidance system application screen 60. In the depicted embodiment, the user 12 opens the application (or “app”) associated with guidance system 10. The application may have various menus, including search menus, park information menus, destination menus, etc. In one embodiment, the application may include a navigation or guidance feature that allows a user to select a destination 22 from a map displayed on the mobile device display screen 52. The map display may also include a user location indicator 62 that is based on the user location information 64 (e.g., GPS information accessed from a GPS chip 66 of the mobile device 20 or user location determined by cellular base station communication). In certain embodiments, the user location indicator 62 is determined by the mobile device itself. In other embodiments, the user location indicator is determined based on feedback from the guidance system 10 after the user location information 64 is provided from the mobile device 20 to the guidance system 10. The user location information 64 may include initial location information and updated location information as the user moves away from the initial location. In certain embodiments, the guidance system 10 is configured to request periodic location updates (e.g., every 10 seconds). In some embodiments, the mobile device 20 may automatically provide the user location information 64. In some embodiments, the user selects a destination 22 from the available destinations, such as those displayed in a map display on the application screen 60. In some embodiments, the user may select from a list of destinations 22 or may select a destination 22 based on a search result within the application. Based on the selection, the application is configured to cause the mobile device 20 to send the user-selected destination information 68 to the guidance system 10.

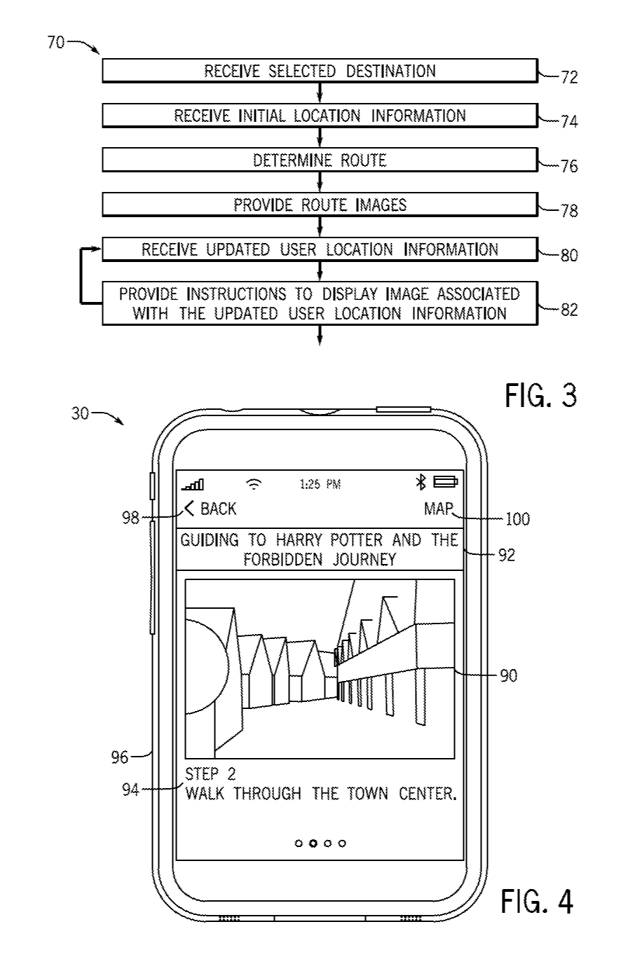

FIG. 3 is a flow diagram of method 70 of providing route or guidance information to the user 12 based on the user's interaction with the mobile device 20. The guidance system 10 receives the user-selected destination information 34 (block 72) and the initial user location information 32 (block 74) and determines the best route for the user 12 (block 76), as discussed herein. The guidance system 10 then transmits one or more images 30 associated with the route to the mobile device 20 (block 78). The mobile device 20 temporarily stores the images 30, e.g., in a memory 36. Once the user 12 progresses on the route and updated user location information is received (block 80), the guidance system 10 also provides instructions to the mobile device to trigger display of an image 30 associated with the updated user location information (block 82). In some embodiments, the mobile device 20 (or, the application stored on the mobile device 20) rather than the guidance system 10 may access updated location information stored in the mobile device 20 to trigger the display screen 28 to display one of the images 30. Blocks 80 and 82 repeat until the user 12 reaches the selected destination according to the updated user location information. In a particular embodiment, the method 70 may return to block 74 if the guidance system 10 receives user location information 64 that indicates that the user 12 is at a location not on the determined route. At that point, the guidance system 10 then determines a new route (block 76) taking into account the new location information.

While the guidance system 10 calculates the route, in certain embodiments of the disclosed techniques, the route is not provided to the mobile device 20. Further, in embodiments of the disclosed techniques, the mobile device 20 also does not calculate or determine any route itself. Instead, the user guidance is provided by a visual path that includes location-associated images, e.g., images 30. The image 30 may only include a photographic image, or may include additional information (e.g., text information related to the photograph).

FIG. 4 is an example of an image 30 and associated information that is sent to the mobile device 20 and displayed. The image 30 may include a photograph 90. The photograph 90 may be a stored (e.g. historical or not real-time) photograph of a location on the route to the destination. The photograph 90 may also be taken from the perspective of a user 12 so that the photograph 90 presents an image of what the user 12 is likely to see while progressing on the route. Accordingly, the guidance system 10 includes a library of images 30 or photographs 90 taken, for example, by a photographer and stored in the system memory, such as memory 40 (see FIG. 2). The photographs 90 may also be taken from the position of a user 12 walking on defined paths and in the same direction as the user is travelling. Accordingly, the guidance system 10 may have a library of images 30 or photographs 90 of the same location, but taken from different directions, and that may be selected based on the direction the user is or should be travelling en route to a desired destination. The appropriate perspective may be selected based on the direction of travel for the user, which may be determined based on user location history or estimated based on the route.

In certain embodiments, the photograph 90 may be selected based on the time of day or season. For example, if the user 12 is progressing on the route during the Christmas season, the image 30 may include a photograph 90 of the location including Christmas decorations. Further, the photograph 90 may be selected based on a time of day, with a nighttime photograph selected when the user makes a route request after sundown (e.g., as determined via a timestamp of the user route request).

The images 30 may include image order information or location information so that the mobile device is able to associate a particular image with location-specific instructions. In one embodiment, the first image 30 automatically displayed is associated with the initial user location or an area close to the initial user location. Accordingly, the user 12 may start the route by orienting to the environment where they are. In addition to the photograph 90, the images 30 may include text-based information to guide the user. For example, the image may include a route header 92 that includes the desired destination. Further, the image 30 may include route instructions 94 that provide context for the photograph 90 as well additional guiding information (e.g., left turn, straight, etc.). While the images 30 are provided to the mobile device to be displayed automatically when the user 12 is at or near the location depicted in the photograph 90, the application may also facilitate an image overview selection 96 that permits the user to scroll through the images 30 in order to see all of the photographs 90 in route order on the way to the desired destination. Accordingly, the images 30 may be provided with information that indicates their order on the route in addition to the location-based display triggering to allow the image overview selection 96 to display the images in order for the user 12 to scroll through.

In addition, the interface for the image overview selection 96 may include an indicator that indicates which image 30 is being displayed (e.g., 2 of 4). In one embodiment, the user 12 may scroll through the images 30 at any point during route progress. If the user leaves an image 30 associated with a past or future location open on the display, the application may automatically trigger a display change when the user 12 enters an area associated with an intervening location image 30. For example, if the user 12 at the start of the route uses the image overview selection 96 to scroll through all of the images 30 so that the displayed image 30 is the last image of the final destination, the user may then start walking from the location associated with the first image 30 and towards the location associated with the second image in the series. Once the user enters a geographic area associated with the second image, the display of the last image 30 stops and the display of the second image 30 is automatically triggered. In some embodiments, the image overview selection 96 may have an automatic timeout before returning to the route progress function that displays the images 30 according to the user location. In certain embodiments of the disclosure, the images 30 are displayed one by one, so that only one image 30 is displayed at a time and triggering the display of a new image 30 automatically stops the display of the previous image 30.

As discussed, the image 30 is sent from the guidance system 10 to the mobile device 20. In addition to the image 30 provided by the guidance system 10, the display screen including the image 30 may also include information generated via the application stored in the mobile device 20. For example, along with the image 30, the display screen may include selectable indicators 98 that facilitate scrolling through the image or indicators 100 that return to other menu screens (e.g., a map from which a new destination may be selected).

The images 30 are associated with particular locations within a geographic area. That is, the photograph 90 is a photograph showing a particular location in, for example, a theme park. Further, the guidance system 10 includes a library of one or more images of pre-selected locations. As noted, a single location may also be associated with a plurality of photographs, depicting the location differently depending on the perspective of the user's direction of travel, the time of day, and/or the season. In particular embodiments, the locations within the geographic area are selected to provide a steady flow of information, e.g., images 30, to the user 12 during any possible route to the pre-determined possible destinations. In one embodiment, the guidance system 10 stores images 30 associated with all of the pre-determined destinations 22 as well as images 30 associated with intervening locations between the pre-determined destinations 22 that are not selectable destinations for which the guidance system 10 can provide route information. For example, images 30 for more pathways or features may be provided but only attraction locations are selectable pre-determined destinations 22. In other embodiments, the images 30 are only associated with the locations of pre-determined destinations 22.

While the system 10 may store a library of images 30 and may send only a subset of the images 30 to the mobile device 20 after determining the user route to the selected destination, in other embodiments, the library may also be housed on the mobile device 20. For example, the library may be downloaded to the mobile device 20 at the time the application is downloaded, i.e., as part of the application data. In such an embodiment, the system 10 may calculate the route and provide instructions to the mobile device to access or otherwise designate only the images 30 associated with the calculated route and trigger the appropriate image 30 for display when the user 12 is in the appropriate location.

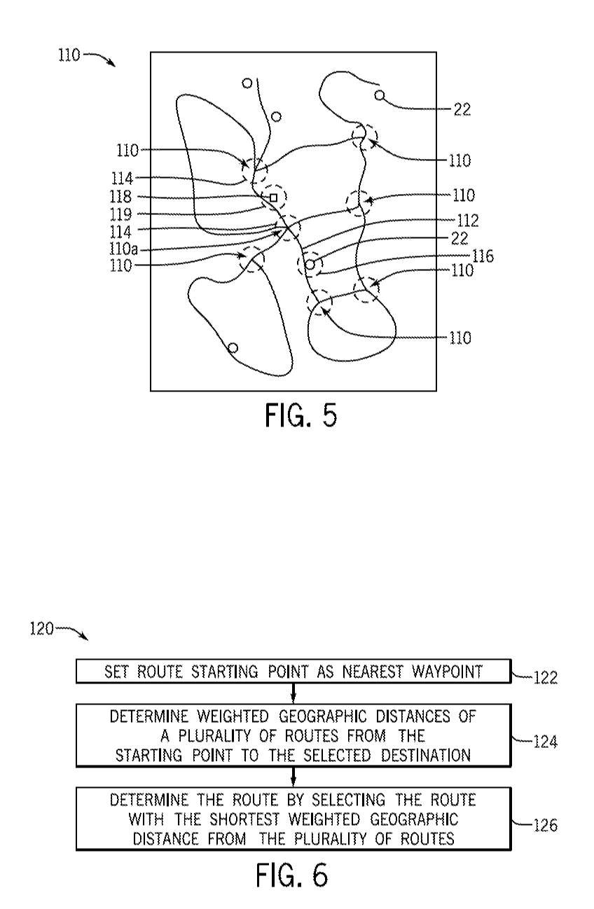

FIG. 5 is a schematic view of a geographic area, such as a park 14 illustrating system interactions in accordance with the present techniques. The guidance system 10, when making route determinations and considering route information, may designate particular locations such as waypoints 110. Waypoints 110 are locations used to designate relevant intersections where a decision can be made. For example, a waypoint 110a is at the junction of four paths 112, and the user 12 may want guidance as to which way to turn. Accordingly, the guidance system 10 may associate one or more images 30 with each waypoint 110, regardless of whether individual waypoints 110 are co-located with a pre-determined destination 22. Accordingly, the guidance system 10 stores geographic data about each waypoint 110, such as the latitude and longitude of the waypoint 110. Further, each waypoint 110 may be a zone having a particular radius.

The guidance system 10 receives periodic updates of user location information 64 and triggers particular actions when the user 12 enters the location within the waypoint zone 114 or other zone. For example, the guidance system 10 may instruct the mobile device 20 to display an image 30 associated with the waypoint zone 114 (i.e., including a photograph 90 of the particular waypoint 110) that the user 12 has entered. The image 30 is maintained in the display until the user 12 enters a new waypoint zone 114 or a destination zone 116. Accordingly, the displayed images 30 may represent the intervening waypoints 110 and/or destinations 22 on the way to the selected destination. Further, a waypoint zone 114 may also include a destination 22. In certain embodiments, the images 30 may also relate to other park features or navigation markers 118 that are not destinations 22 or waypoints 110, but are simply useful navigation markers on the route. When a user enters a navigation marker zone 119, an image 30 associated with the navigation marker 118 is displayed. In the event that the geographic area includes overlapping zones, such as when a destination 22 is relatively close to a waypoint 110, the user 12 is considered to be in the most-recently entered zone. Accordingly, moving to a new zone partially within a previously entered zone triggers display of a new image 30 associated with the new zone.

The guidance system 10 also considers paths 112 as representations of accessibility between two waypoints 110 or a waypoint 110 and a destination 22. In addition to geographic data associated with the possible routes to any destination, the guidance system 10 may also store historical visitor information and/or crowd information for one or more destinations 22 that may be used for determining a route. Accordingly, the guidance system 10 may consider one or more of the following inputs when determining a route:

StartingWaypoint—the waypoint 110 both closest to the user 12 and on the way to the destination 22. The starting waypoint could be the waypoint that the user is already in or could be a waypoint that the user 12 walks to at the initial stage of the route. Further, the starting waypoint may not be the closest waypoint 110 if a waypoint 110 behind the user is actually closer, but not on the calculated route.

EndingWaypoint (nullable)—the desired destination, which may be co-located with a waypoint 110.

DestinationPointOfinterest (nullable)—the desired destination, not co-located with a waypoint 110.

Destination-Associated Data: Latitude, Longitude, Additional Information

FIG. 6 is a flow diagram of a method 120 of determining a route according to the present techniques. After the guidance system 10 receives the initial user location information, the route starting point is set as the nearest waypoint (block 122). In some embodiments, the route starting point may be set as the nearest zone or at any zone that the user 12 is within per the initial user location information. While the route determination may consider weighting (balancing of available inputs to select one or more preferred options) when determining geographic distances on the route, the guidance system 10 may select the route starting point without regard to any weighting, but may simply select the nearest zone in terms of unweighted geographic distance. The guidance system 10 then determines a weighted geographic distance for all possible routes to the selected destination 22 (block 124). The weighted geographic distance may assign additional weight to paths 112 that have high crowds per stored historical information. The weighted geographic distance may also assign higher weights to paths connecting one or more historically crowded waypoints 110 or destinations 22 to steer users towards less routes. The weighted geographic distance for a particular route may be the sum of the weighted distances of the paths 114, destinations 22, and waypoints 110 that make up a particular route. After considering the weighted geographic distances of all of the routes, the route associated with the user 12 is determined by selecting the route with the shortest weighted geographic distance from the plurality of routes (block 126). After the route is determined, the route images 30 may be provided to the user's mobile device 20 as disclosed herein. In other embodiments, higher or lower weight may be assigned based on desired attributes (e.g., (low estimated crowds) or undesired attributes (e.g., high estimated crowds) and routes selected accordingly. In one embodiment, events on the routes may be desirable or undesirable based on user preferences. For example, if a particular path 112 or waypoint 110 is host to a parade, certain users 12 may find special events desirable while other users 12 may find such events undesirable and may seek to avoid crowds as much as possible. Accordingly, in one embodiment, the guidance system 10 may receive user preferences from the mobile device 20 as inputs. Such preferences could be selected from available menus. In one example, the selections may also appear as prompts before the route is determined. For example, if a user 12 selects the Hogwarts Express as a desired destination 22, one possible route may take the user 12 past the TriWizard Spirit Rally demonstration in Hogsmeade village. If the system 10 determines that the demonstration is active or that the user 12 will pass Hogsmeade village at a time close to a demonstration start time, the system 10 may instruct the mobile device 20 to prompt the user to enter a preference for seeing the demonstration. If the user 12 wishes to see the demonstration, a route that passes through demonstration in Hogsmeade village as an intervening location is calculated. If not, a different route that bypasses the demonstration is calculated.

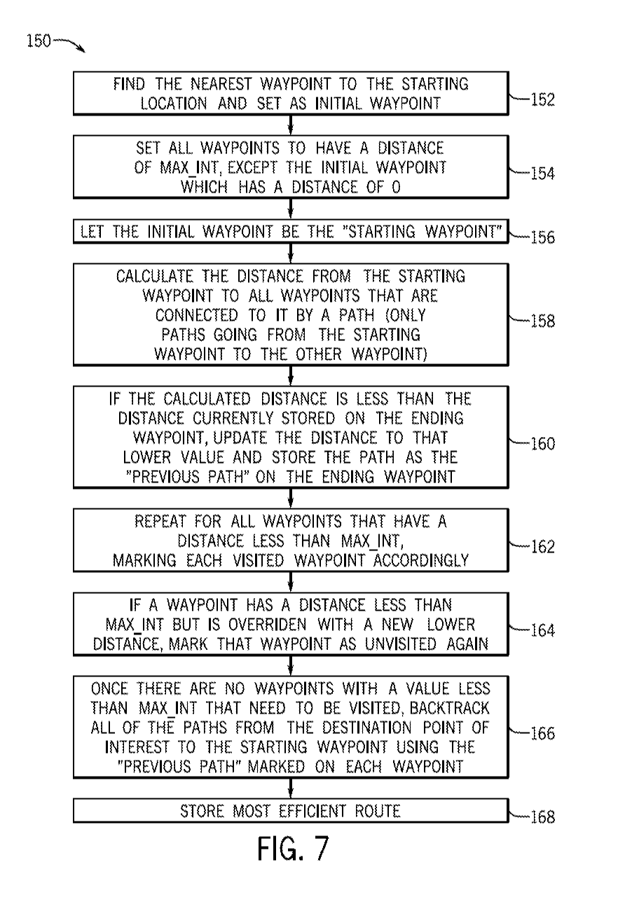

In one embodiment, the routing algorithm uses a variation of Dijkstra's Algorithm with variable inputs to the routing algorithm (1) the initial location as a latitude, longitude pair and (2) a destination point of interest specified by a destination ID. FIG. 7 is a flow diagram of a method 150 using such logic. The method 150 finds the nearest waypoint to the starting location and sets this as the “initial waypoint” (block 152). All waypoints from the initial waypoint are set to have a distance of MAX_INT, representing a longest possible route, except the initial waypoint which has a distance of 0 (block 154). With the initial waypoint as the “starting waypoint” (block 156), the method 150 calculates the distance from the starting waypoint to all waypoints that are connected to it by a path (only paths going from the starting waypoint to the other waypoint) (block 158). That is, the routes are limited to going away from the starting waypoint. The distance for each ending waypoint is calculated by multiplying the path's weight by the geographic distance, in miles, between the waypoints and then adding the current distance of the starting waypoint. The distance weight of the paths may be determined as provided herein (e.g., based on estimated crowds or desired or undesired events or features).

The ending destination of the route may be a point of interest and not a waypoint 110 if the path is a “leaf path” going to the selected destination instead of a waypoint (see, e.g., destination 22g, FIG. 1). However, only leaf paths that go to the selected destination 22 should be calculated since it is assumed there are no outgoing paths from the selected destination 22. Any leaf path not going to the selected destination 22 should not be considered. That is, in the example of FIG. 1, the user 12 has selected 22i as a desired destination. Because 22g terminates on a leaf path that is not the desired destination 22, the path between 22i and the waypoint associated with the intersection at 22e may be nulled. If the calculated distance is less than the distance currently stored on the ending waypoint, update the distance to that lower value and store the path as the “previous path” on the ending waypoint.

The distance calculated is repeated on all waypoints that have a distance less than MAX_INT, marking each visited waypoint accordingly (block 162). If a waypoint has a distance less than MAX_INT but is overridden with a new lower distance, mark that waypoint as unvisited again (block 164). That waypoint's distances are recalculated if they now have a lower value. Once there are no waypoints with a value less than MAX_INT that need to be visited, backtrack all of the paths from the selected destination 22 to the starting waypoint using the “previous path” marked on each waypoint (block 166). This is the most efficient route to take, and this most efficient route is stored (block 168) to facilitate further actions, e.g. selecting images 30 associated with the stored route or accessing previously selected images associated with the stored route.

For example, once the most efficient route is determined, the guidance system 10 returns the list of routes with links to the associated images. If specified, the guidance system 10 can also return the waypoints in the route or all of the possible waypoints. The guidance system display 38 may show the route path by path, displaying the image, instructions, and comments. However, this information is not provided to the user 12. The first path displayed will be going to the second waypoint since there is no path from an arbitrary starting location to the starting waypoint. In one embodiment, the images 30 are associated with paths and not waypoints, and are taken from the starting waypoint of the path and in the direction of the ending waypoint. Once the user is within the specified radius of a waypoint, the guidance system 10 starts displaying information for the next path on the display 38. In one embodiment, the final path to the destination point of interest includes an image of the front of the point of interest, which may or may not be from the perspective of the starting waypoint or the user's direction of travel.

While only certain features of the invention have been illustrated and described herein, many modifications and changes will occur to those skilled in the art. It is, therefore, to be understood that the appended claims are intended to cover all such modifications and changes as fall within the true spirit of the invention. While certain disclosed embodiments have been disclosed in the context of amusement or theme parks, it should be understood that certain embodiments may also relate to other pedestrian destinations, including city parks, state parks, museums, etc. Further, it should be understood that certain elements of the disclosed embodiments may be combined or exchanged with one another.

1. A system for guiding a user to a destination comprising:
a memory storing instructions that, when executed, are configured to:
receive a user input from a mobile device comprising a desired destination selected from a pre-determined set of destinations in a geographic area;
receive initial user location information in the geographic area from the mobile device;
determine a pedestrian route for the user to the desired destination through pre-determined waypoints based on the initial user location;
associate the pedestrian route with a plurality of images corresponding to respective intervening locations on the pedestrian route that the user will encounter while progressing on the pedestrian route to the destination; and
provide instructions to the mobile device to automatically trigger a display of one individual image of the plurality of images when the user is in a respective intervening location that corresponds to the individual image based on updated user location information from the mobile device, wherein the updated user location information is subsequent to the initial location information; and
one or more processors configured to execute the instructions.

2. The system of claim 1, wherein at least one image of the plurality of images comprises text information about a respective location shown in the at least one image.

3. The system of claim 1, wherein the system is configured to not provide any map of the pedestrian route or instructions for generating the map of the pedestrian route to the mobile device.

4. The system of claim 1, wherein the memory stores instructions configured to transmit the plurality of images to the mobile device.

5. The system of claim 1, wherein the plurality of images are only a subset of images in a library of images stored in the memory, wherein the library of images comprises image that are not associated with the pedestrian route.

6. The system of claim 1, wherein the memory stores instructions configured to instruct the mobile device to access the images from a mobile device memory.

7. The system of claim 1, wherein the pre-determined set of destinations comprises one or more amusement park rides.

8. The system of claim 1, wherein the waypoints correspond to intersections where a decision can be made and wherein the geographic area comprises a plurality of waypoints.

9. The system of claim 8, wherein the instructions to determine the pedestrian route comprise instructions configured to:
determine a nearest waypoint to the initial location and setting the nearest waypoint as a starting waypoint; and
determine a distance from the starting waypoint to each individual waypoint connected to the starting waypoint by a path.

10. The system of claim 9, wherein the instructions to determine the distance from the starting waypoint to each individual waypoint connected to the starting waypoint comprise instructions configured to:
weighting a geographic distance between the respective individual waypoint and the starting waypoint by a weighting factor associated with a connecting path between the respective waypoint and the starting waypoint.

11. The system of claim 10, wherein the instructions to determine the pedestrian route comprise instructions configured to:
determine a most efficient route based on a shortest total distance between the starting waypoint and the destination, wherein the shortest total distance represents the weighted geographic distance between the starting waypoint and the destination.

12. The system of claim 10, wherein the weighting factor comprises the historical pedestrian information for the connecting path.

13. The system of claim 1, wherein the memory stores instructions to instruct the mobile device to automatically trigger a display of a subsequent image of the plurality of images when the user is in a respective location that corresponds to the subsequent individual image based on the updated user location information from the mobile device.

14. The system of claim 13, wherein the instructions to display the subsequent image also stop display of the individual image such that only the subsequent image is displayed.

15. The system of claim 1, wherein the system does not provide any pedestrian route information to the mobile device.

16. The system of claim 1, wherein the memory stores instructions configured to transmit the plurality of images to the mobile device only after the desired destination is received and wherein the instructions to the mobile device to automatically trigger a display of individual image are subsequent to the mobile device receiving the plurality of images.

17. The system of claim 1, wherein the memory stores instructions configured to provide additional images to the mobile device if the updated user location information is associated with a new pedestrian route to the destination.

18. A system, comprising:
a mobile device configured for wireless communication, the mobile device being configured to execute instructions to:
transmit a selected destination from a pre-determined set of destinations in a geographic area;
transmit initial location information accessed from a memory of the mobile device;
receive a plurality of images that correspond to intervening locations on a pedestrian route to the destination and that the user will encounter while progressing on the pedestrian route to the destination;
transmit updated location information accessed from a memory of the mobile device when the mobile device moves away from the initial location; and
trigger a display an individual image of the plurality of images when the user is in a respective intervening location that corresponds to the individual image based on the updated location information, wherein the updated user location information is subsequent to the initial location information; and
one or more processors configured to execute the instructions.

19. The system of claim 18, wherein the instructions are associated with an application stored on the mobile device.

20. The system of claim 18, wherein the mobile device is configured to execute instructions to temporarily store the plurality of images in the memory.

21. The system of claim 18, wherein the mobile device is configured to execute instructions to access and display a map stored on the mobile device, wherein the selected destination is selected via an icon displayed on the map.

22. The system of claim 21, wherein the mobile device is configured to execute instructions to stop display of the map after the plurality of images are received.

23. The system of claim 21, wherein the pedestrian route is not displayed on the map.

24. The system of claim 18, wherein the mobile device does not determine the pedestrian route.

25. The system of claim 18, comprising a guidance system comprising a memory storing instructions that, when executed, are configured to:
receive the selected destination and the user location information from the mobile device; and
determine the pedestrian route for the user to the selected destination; and
one or more guidance system processors configured to execute the instructions.

26. A method comprising:
receiving information indicating a selected destination from a pre-determined set of destinations in a geographic area and initial user location information;
determining a pedestrian route for the user to the destination through pre-determined waypoints based on the initial user location, wherein determining the pedestrian route comprises determining weighted geographic distances of a plurality of routes to the destination and selecting a route with a smallest or largest weighted geographic distance; and
providing a plurality of images to the mobile device that correspond to respective intervening locations on the pedestrian route that the user will encounter while progressing on the pedestrian route to the destination.

27. The method of claim 26, comprising providing instructions to automatically trigger a display of an individual image of the plurality of images when the user location information corresponds to a location of the individual image.

28. The method of claim 26, wherein providing the plurality of images comprises providing only a subset of a library images, wherein the library comprises images corresponding to unselected destinations that are not on the pedestrian route that are not provided to the mobile device.

29. The method of claim 26, wherein providing the plurality of images comprises selecting one image of an individual location from a plurality of images of the individual location based on a time of day or a season.

30. The method of claim 26, wherein providing the plurality of images comprises selecting one image of a individual location from a plurality of images of the individual location based on an estimated or determined direction of user travel.
